(19) United States
(12) Patent Application Publication
(10) Pub. No.: US 2025/0166295 A1
(43) Pub. Date: May 22, 2025

(54) 3D RECONSTRUCTION

(71) Applicant: Telefonaktiebolaget LM Ericsson (publ), Stockholm (SE)

(72) Inventors: José ARAÚJO, Stockholm (SE); André MATEUS, Uppsala (SE); Alejandra HERNANDEZ SILVA, Solna (SE); Clara GOMEZ BLAZQUEZ, Solna (SE); Paula CARBÓ CUBERO, Stockholm (SE)

(21) Appl. No.: 18/834,873

(22) PCT Filed: Feb. 16, 2022
(86) PCT No.: PCT/EP2022/053835

§ 371 Date: Jul. 31, 2024

(51) Int. Cl. G06T 17/00; G06T 7/00; G06T 7/70

(52) U.S. Cl. CPC G06T 17/00; G06T 7/0002; G06T 7/70

(57) ABSTRACT

It is provided a method for performing 3D reconstruction. The method includes: obtaining sensor data; determining a pose estimate; estimating a pose error; comparing the pose error against an error threshold; performing a device 3D reconstruction when the pose error is determined to be smaller than the error threshold, resulting in updates to a device 3D model; sending a 3D reconstruction request to the server to perform a central 3D reconstruction, when the pose error is determined to be greater than the error threshold, wherein the 3D reconstruction request includes data based on the sensor data; receiving a result of a central 3D reconstruction from the server; and performing a 3D model fusion of a device 3D model in the mobile device and the result of the central 3D reconstruction, wherein the device 3D model, at least partly, is a result of previous device 3D reconstruction.

### TECHNICAL FIELD

The present disclosure relates to the field of 3D (three-dimensional) reconstruction and in particular to 3D reconstruction for use in a model of a physical environment captured by at least one sensor of a mobile device, based on 3D reconstruction by a server and a mobile device.

### BACKGROUND

Localisation is used for many applications, such as self-driving cars, unmanned aerial vehicles, robots, as well as for augmented reality (AR) and virtual reality (VR) applications (AR and VR is collectively denoted extended reality (XR)). Localisation is the process of determining the pose of a device or object in a 3D model of a physical space. Pose is defined by object position and object orientation, each defined in three dimensions.

The 3D model can be generated using visual and/or depth sensors such as monocular cameras, stereo cameras and Lidars. This process is defined as 3D reconstruction.

The 3D reconstruction is based on determining the pose of the sensor for each sensor data input and determination of 3D data from each sensor data input. All 3D data is then fused to create a complete 3D model of the physical space around the sensor(s).

If the device only has a monocular camera, 3D reconstruction can still be applied using a technique known as structure from motion, which can be combined with multi-view stereo. However, such processing is computationally expensive and thus resource demanding, and is performed offline. Recently, interest has increased in performing 3D reconstruction in real-time, e.g. for the purposes of navigation (robots) and augmented reality (smartphones and XR glasses). This can e.g. be achieved using a Simultaneous Localisation and Mapping (SLAM) algorithm for pose determination, followed by real-time 3D reconstruction.

However, all the 3D reconstruction of the prior art is computationally expensive, particularly when the real-time SLAM algorithm provides inaccurate pose estimates in challenging environments and operating conditions (e.g. high speed), which requires the computationally expensive refinement of the SLAM poses in the reconstruction for obtaining an accurate 3D model. The computationally expensive reconstruction is too resource demanding to be a realistic alternative for being performed in a mobile device. There are more energy-efficient reconstruction algorithms, but these lack accuracy, at least in some scenarios.

### SUMMARY

One object is to provide an improved balance between energy-efficient and accurate 3D reconstruction.

According to a first aspect, it is provided a method for performing 3D, three-dimensional, reconstruction for use in a model of a physical environment captured by at least one sensor of a mobile device. The method is performed by a system comprising the mobile device and a server. The method comprises: obtaining, by the mobile device, sensor data from sensors of the mobile device; determining, by the mobile device, a pose estimate of the mobile device based on the sensor data; estimating, by the mobile device, a pose error of the pose estimate; comparing, by the mobile device, the pose error against an error threshold; performing, by the mobile device, a device 3D reconstruction when the pose error is determined to be smaller than the error threshold, resulting in updates to a device 3D model; sending, by the mobile device, a 3D reconstruction request to the server, when the pose error is determined to be greater than the error threshold, wherein the 3D reconstruction request comprises data based on the sensor data; performing, by the server, a central 3D reconstruction based on the 3D reconstruction request; sending, by the server, a result of the central 3D reconstruction to the mobile device; and performing, by the mobile device, a 3D model fusion of a device 3D model in the mobile device and the result of the central 3D reconstruction, wherein the device 3D model, at least partly, is a result of previous device 3D reconstruction.

According to a second aspect, it is provided a method for performing 3D, three-dimensional, reconstruction for use in a model of a physical environment captured by at least one sensor of a mobile device, the method being performed by the mobile device. The method comprises: obtaining sensor data from sensors of the mobile device; determining a pose estimate of the mobile device based on the sensor data; estimating a pose error of the pose estimate; comparing the pose error against an error threshold; performing a device 3D reconstruction when the pose error is determined to be smaller than the error threshold, resulting in updates to a device 3D model; sending a 3D reconstruction request to the server to perform a central 3D reconstruction, when the pose error is determined to be greater than the error threshold, wherein the 3D reconstruction request comprises data based on the sensor data; receiving a result of a central 3D reconstruction from the server; and performing a 3D model fusion of a device 3D model in the mobile device and the result of the central 3D reconstruction, wherein the device 3D model, at least partly, is a result of previous device 3D reconstruction.

The sensors may include at least a camera.

The determining a pose estimate may be based on a SLAM, simultaneous localisation and mapping, procedure.

The estimating a pose error may comprise determining a pose error based on an odometry component that is usable for the SLAM procedure.

The estimating a pose error may comprise reducing the pose error when a localisation of the mobile device in the SLAM procedure occurs.

The estimating a pose error may comprise setting the pose error to zero when a localisation of the mobile device in the SLAM procedure occurs.

The device 3D reconstruction, on average, may be less resource demanding and less accurate than the central 3D reconstruction.

The result of the central 3D reconstruction may comprise a pose of the mobile device determined by the server.

The method may further comprise: adjusting the error threshold to decrease the error threshold when a quality of a device 3D reconstruction is greater than a quality threshold.

The adjusting may comprise adjusting the error threshold based on a central pose error indication received from the server.

The 3D reconstruction request may comprise at least part of a most recent device 3D model and sensor data obtained after determining the most recent device 3D model.

The 3D reconstruction request may comprise the pose estimate.

The 3D reconstruction request may comprise at least part of the device 3D model built after the most recent loop closure or localisation event.

The method may be repeated.

According to a third aspect, it is provided a mobile device for performing 3D, three-dimensional, reconstruction for use in a model of a physical environment captured by at least one sensor of the mobile device. The mobile device comprises: a processor; and a memory storing instructions that, when executed by the processor, cause the mobile device to: obtain sensor data from sensors of the mobile device; determine a pose estimate of the mobile device based on the sensor data; estimate a pose error of the pose estimate; compare the pose error against an error threshold; perform a device 3D reconstruction when the pose error is determined to be smaller than the error threshold, resulting in updates to a device 3D model; send a 3D reconstruction request to the server to perform a central 3D reconstruction, when the pose error is determined to be greater than the error threshold, wherein the 3D reconstruction request comprises data based on the sensor data; receive a result of a central 3D reconstruction from the server; and perform a 3D model fusion of a device 3D model in the mobile device and the result of the central 3D reconstruction, wherein the device 3D model, at least partly, is a result of previous device 3D reconstruction.

The sensors may include at least a camera.

The instructions to determine a pose estimate may comprise instructions that, when executed by the processor, cause the mobile device to determine the pose estimated based on a SLAM, simultaneous localisation and mapping, procedure.

The instructions to estimate a pose error may comprise instructions that, when executed by the processor, cause the mobile device to determine a pose error based on an odometry component that is usable for the SLAM procedure.

The instructions to estimate a pose error may comprise instructions that, when executed by the processor, cause the mobile device to reduce the pose error when a localisation of the mobile device in the SLAM procedure occurs.

The instructions to estimate a pose error may comprise instructions that, when executed by the processor, cause the mobile device to set the pose error to zero when a localisation of the mobile device in the SLAM procedure occurs.

The result of the central 3D reconstruction may comprise a pose of the mobile device determined by the server.

The mobile device may further comprise instructions that, when executed by the processor, cause the mobile device to adjust the error threshold to decrease the error threshold when a quality of a device 3D reconstruction is greater than a quality threshold.

The instructions to adjust may comprise instructions that, when executed by the processor, cause the mobile device to adjust the error threshold based on a central pose error indication received from the server.

The 3D reconstruction request may comprise at least part of a most recent device 3D model and sensor data obtained after determining the most recent device 3D model.

The 3D reconstruction request may comprise the pose estimate.

According to a fourth aspect, it is provided a computer program for performing 3D, three-dimensional, reconstruction for use in a model of a physical environment captured by at least one sensor of a mobile device. The computer program comprises computer program code which, when executed on the mobile device causes the mobile device to: obtain sensor data from sensors of the mobile device; determine a pose estimate of the mobile device based on the sensor data; estimate a pose error of the pose estimate; compare the pose error against an error threshold; perform a device 3D reconstruction when the pose error is determined to be smaller than the error threshold, resulting in updates to a device 3D model; send a 3D reconstruction request to the server to perform a central 3D reconstruction, when the pose error is determined to be greater than the error threshold, wherein the 3D reconstruction request comprises data based on the sensor data; receive a result of a central 3D reconstruction from the server; and perform a 3D model fusion of a device 3D model in the mobile device and the result of the central 3D reconstruction, wherein the device 3D model, at least partly, is a result of previous device 3D reconstruction.

According to a fifth aspect, it is provided a computer program product comprising a computer program according to the fourth aspect and a computer readable means comprising non-transitory memory in which the computer program is stored.

According to a sixth aspect, it is provided a method for performing 3D, three-dimensional, reconstruction for use in a model of a physical environment captured by at least one sensor of a mobile device. The method is performed by a server. The method comprises: receiving a 3D reconstruction request from the mobile device, wherein the 3D reconstruction request comprises data based on sensor data obtained by sensors of the mobile device; performing a central 3D reconstruction based on the 3D reconstruction request; and sending a result of the central 3D reconstruction to the mobile device.

The method may further comprise adjusting the error threshold based on a central pose error indication received from the server.

The result of the central 3D reconstruction may comprise a pose of the mobile device determined by the server.

According to a seventh aspect, it is provided a server for performing 3D, three-dimensional, reconstruction for use in a model of a physical environment captured by at least one sensor of a mobile device. The server comprises: a processor; and a memory storing instructions that, when executed by the processor, cause the server to: receive a 3D reconstruction request from the mobile device, wherein the 3D reconstruction request comprises data based on sensor data obtained by sensors of the mobile device; perform a central 3D reconstruction based on the 3D reconstruction request; and send a result of the central 3D reconstruction to the mobile device.

The server may further comprise instructions that, when executed by the processor, cause the server to adjust the error threshold based on a central pose error indication received from the server.

The result of the central 3D reconstruction may comprise a pose of the mobile device determined by the server.

According to an eighth aspect, it is provided a computer program for performing 3D, three-dimensional, reconstruction for use in a model of a physical environment captured by at least one sensor of a mobile device. The computer program comprising computer program code which, when executed on a server causes the server to: receive a 3D reconstruction request from the mobile device, wherein the 3D reconstruction request comprises data based on sensor data obtained by sensors of the mobile device; perform a central 3D reconstruction based on the 3D reconstruction request; and send a result of the central 3D reconstruction to the mobile device.

According to a ninth aspect, it is provided a computer program product comprising a computer program according to the eighth aspect and a computer readable means comprising non-transitory memory in which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

Aspects and embodiments are now described, by way of example, with reference to the accompanying drawings, in which:

FIG. 1 is a schematic diagram illustrating an environment in which embodiments presented herein can be applied;

FIG. 2 is a schematic drawing illustrating the components of a system according to one embodiment;

FIGS. 3A-B are swimlane diagrams illustrating embodiments of methods performed by the mobile device and the server of FIG. 1 for performing 3D reconstruction according to various embodiments;

FIG. 4 is a schematic diagram showing functional modules of the mobile device of FIG. 1 according to one embodiment;

FIG. 5 is a schematic diagram showing functional modules of the server of FIG. 1 according to one embodiment;

FIG. 6 is a schematic diagram illustrating components of the mobile device and the server of FIG. 1; and

FIG. 7 shows one example of a computer program product comprising computer readable means.

### DETAILED DESCRIPTION

The aspects of the present disclosure will now be described more fully hereinafter with reference to the accompanying drawings, in which certain embodiments of the invention are shown. These aspects may, however, be embodied in many different forms and should not be construed as limiting; rather, these embodiments are provided by way of example so that this disclosure will be thorough and complete, and to fully convey the scope of all aspects of invention to those skilled in the art. Like numbers refer to like elements throughout the description.

According to embodiments presented herein, a solution is provided to perform accurate 3D reconstruction of an environment, based on 3D reconstruction both in a mobile device and a server. The mobile device comprises e.g. a camera and/or a depth sensor (e.g., stereo camera, Lidar). A pose estimate of the mobile device is determined, e.g. using SLAM. An indication of pose error of the pose estimation is then determined. If the pose error is smaller than an error threshold, a lightweight 3D reconstruction is performed by the mobile device, since the relatively low pose error implies a relatively high 3D reconstruction accuracy in the mobile device, (which can be performed with low computational cost). On the other hand, when the error is higher than the error threshold, a more demanding, but accurate, 3D reconstruction is performed by the server, since the relatively high pose error indicates that a refinement of the pose of the mobile device is required, which is performed by the server due to high computational cost.

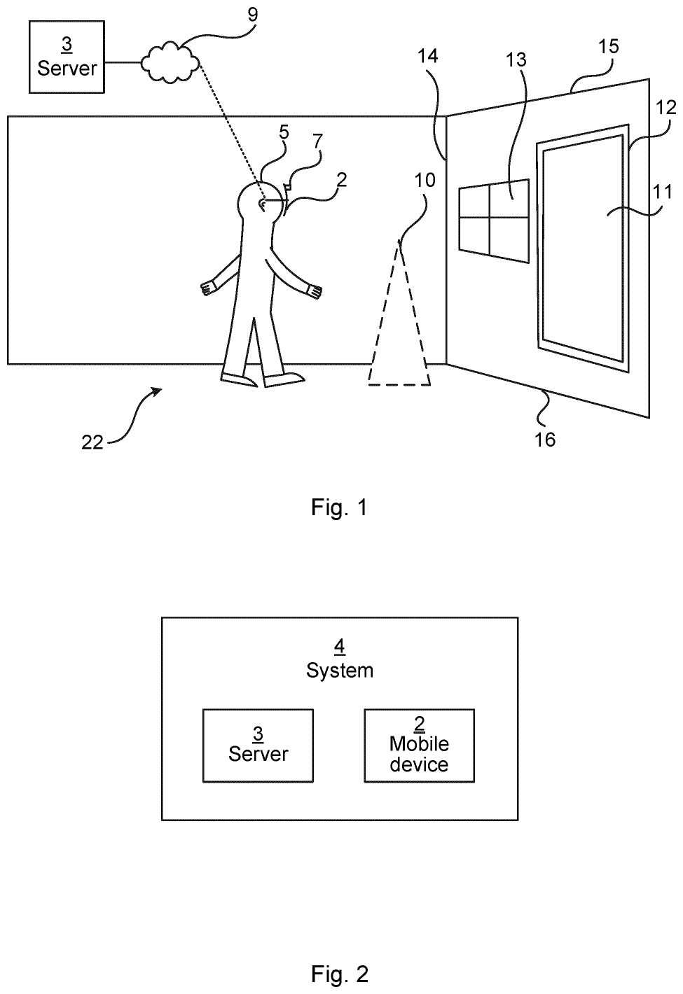

FIG. 1 is a schematic diagram illustrating an environment in which embodiments presented herein can be applied. A physical space 22 is shown in FIG. 1. A mobile device 2 is present in the mobile space. The physical space 22 can be defined as a three-dimensional (3D) or two-dimensional (2D) space.

In this example, a user 5 wears or carries a mobile device 2, such as a head mounted display (HMD). This can e.g. be used in an XR context, which allows the user 5 to see both real-world objects 11-16 and a virtual object 10. Virtual objects are rendered by the mobile device 2 and do not exist as physical objects in the physical space 22. The mobile device 2 contains movement sensors (e.g. accelerometer, gyro, odometer, etc.). Some of these sensors can be part of an inertia measurement unit (IMU). The IMU is used to obtain data which contributes to determining the pose of the mobile device 2 in a 3D space. Pose is here defined as a position and orientation in the physical space 22, each defined in three dimensions. Alternatively, the mobile device 2 can be implemented using a smartphone, a tablet computer, a vehicle (autonomous, remote controlled, or traditional), a robot, or any other device that would benefit from localisation in and/or mapping of the physical space 22.

The mobile device 2 comprises one or more sensors 7 for capturing images and/or depth data of the environment around the user 5. Each sensor 7 can e.g. be implemented as a camera (2D or depth camera), lidar, radar, time-of-flight sensor etc.

The mobile device 2 is connected to a network 9. The network 9 can e.g. be made up of any one or more of a Wi-Fi network, local area network (LAN), a wide area network (WAN) such as the Internet and a cellular network. A server 3 is also connected to the network 9.

According to embodiments presented herein, 3D reconstruction of a model of the physical space 22 occurs both by the server 3 and the mobile device 2. The server 3 is used for server reconstruction of the model of the physical space 22 and the mobile device 2 is used for device reconstruction of the model of the physical space 22.

The device reconstruction is based on a lightweight 3D reconstruction that is (on average) more resource efficient, but less accurate than the server reconstruction. On the other hand the server reconstruction is based on a heavyweight 3D reconstruction that is (on average) less resource efficient, but more accurate than the device reconstruction. In each iteration of a method, the mobile device 2 determines where the 3D reconstruction is to be performed (mobile device or server) based on an indicator of pose error of the pose determined by the mobile device.

It is to be noted that the environment of FIG. 1 is only one example of where localisation based on localisation maps is supported. Embodiments presented herein can equally well be applied in other environments, such as for self-driving vehicles, industrial applications, indoor robotics, etc.

FIG. 2 is a schematic drawing illustrating the components of a system 4 according to one embodiment presented herein. The drawing of FIG. 2 clarifies that a system 4 can be provided, that comprises at least one server 3 and at least one mobile device 2.

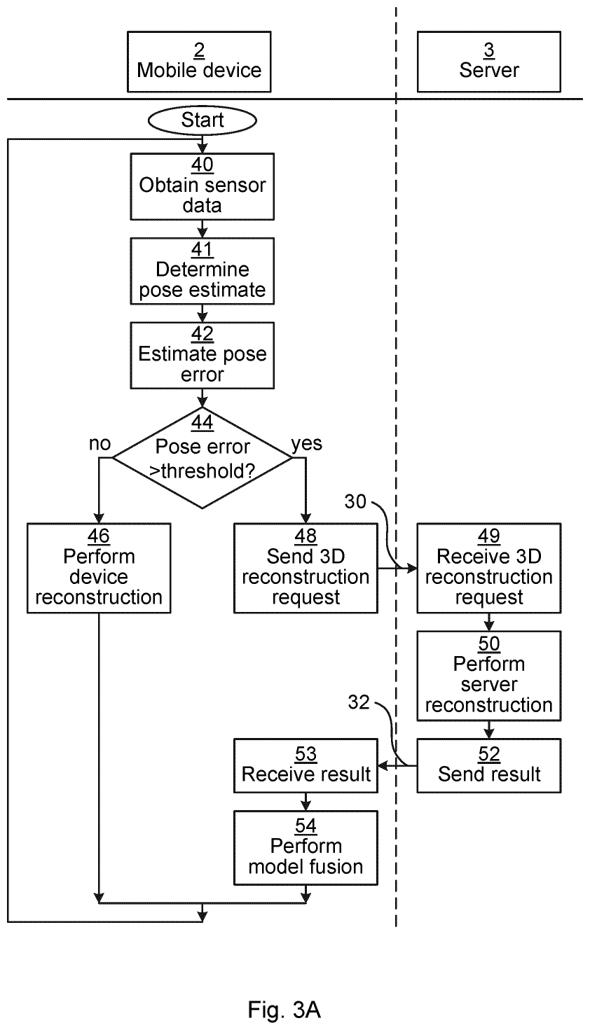

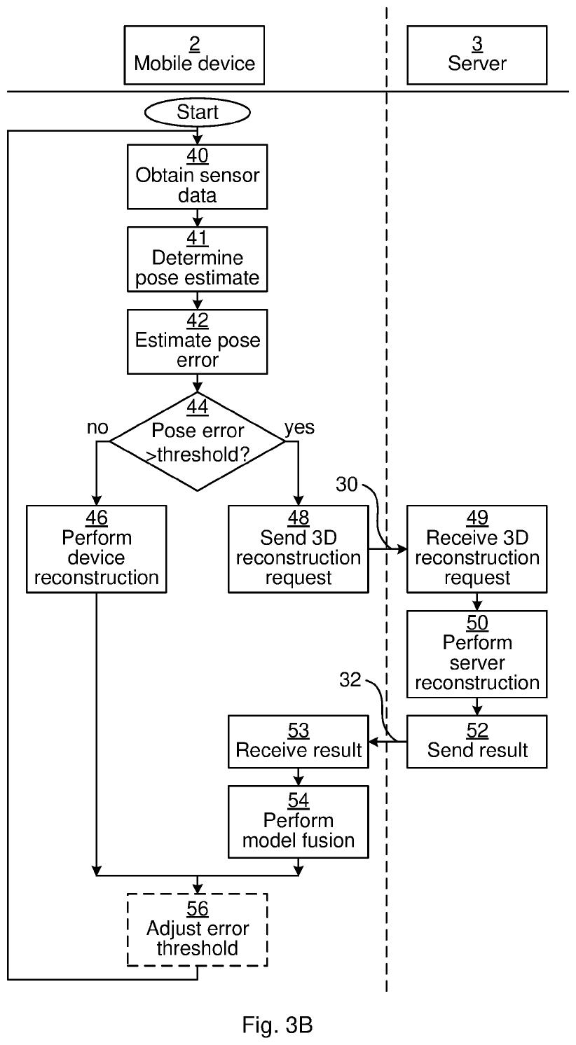

FIGS. 3A-B are swimlane diagrams illustrating embodiments of methods performed by the mobile device 2 and the server 3 of FIG. 1 for performing 3D reconstruction according to various embodiments. The steps performed by the mobile device 2 form part of a method performed by the mobile device. Analogously, the steps performed by the server 3 form part of a method performed by the server 3. Collectively, the steps performed by the mobile device 2 and the server 3 form part of a method performed by the system 4. First, the methods illustrated in FIG. 3A will be described.

In an obtain sensor data step 40, the mobile device 2 obtains sensor data from sensors 7 of the mobile device 2. As explained above, the sensors can include at least a camera. The sensor data can also include movement data, e.g. from an IMU and/or odometer of the mobile device 2. The movement data can include acceleration in one or more dimensions, and/or gyro data in one or more dimensions. The odometer data is an indication of a travelled distance from a certain point in space and/or point in time.

In a determine pose estimate step 41, the mobile device 2 determines a pose estimate of the mobile device 2 based on the sensor data. The determining a pose estimate can be based on a SLAM (simultaneous localisation and mapping) procedure. When a map is not available (no current localisation on a map occurs), the pose can be estimated based on an odometry component that is usable for the SLAM procedure, for example Visual-Inertial Odometry (VIO) when at least one IMU and one image sensor is available, or wheel rotation for a vehicle with wheels.

In an estimate pose error step 42, the mobile device 2 estimates a pose error of the pose estimate. When a map of the current area is not available, and the pose estimate is provided by the odometry component, an exponential drift is imposed on the pose estimate.

Determining the exact pose estimate error is not possible without a ground truth signal, which is typically not the case where embodiments presented herein are applied. However, an indicator of the pose estimate error can be determined, that approximates the true pose estimate error and can be used by embodiments presented herein.

As the mobile device continues to move and revisits an area that has been recently mapped, a “loop closure” occurs (correspondences between map elements are established) which allows for a pose estimate refinement and drift decrease. For example, the pose estimation error at iteration k of the method (denoted error(k)) may decrease by a factor of a α<1 when a loop closure occurs: error(k)=α*error(k−1), and may increase by a factor of β>1 otherwise: error(k)=β*error(k−1).

Optionally, when a successful localisation of the mobile device occurs in the SLAM procedure, this results in reducing the pose error. For instance, the estimating a pose error can comprise setting the pose error to zero when a localisation of the mobile device in the SLAM procedure occurs. In other words, when a map of the current area is already known and is available, the pose estimate error can be reset (e.g. set to zero) at time k*, when a match between the sensor data obtained at time k* and an available map is found (localisation step in a SLAM algorithm). Hence, if this condition occurs, then error (k*)=0, after which the error might grow according to the odometry drift for k>k*.

One indicator of pose error is a pose distance, defined as the distance difference between two consecutive poses. The value of the indicator of pose estimate error is then given by error(k)=|pose_estimate(k)−pose_estimate(k−1)| where pose_estimate(k) is the pose estimated at iteration k.

The indicator of pose error can be an instantaneous value, or a value determined based on several iterations of the method. For example, the mean value of the pose distance over a defined moving time window can be defined as the indicator of pose error in this step.

In a conditional pose error>threshold step 44, the mobile device 2 compares the pose error against an error threshold. When the pose error is greater than the error threshold, the method proceeds to a send 3D reconstruction request step 48 to offload 3D reconstruction to the server 3. Otherwise, the method proceeds to a perform device reconstruction step 46, where the 3D reconstruction is performed by the mobile device 2. The device 3D reconstruction, on average, is less resource demanding and less accurate than the server 3D reconstruction. Since the server 3 has more resources, and is likely mains powered (i.e. wired power), the server 3 can be used for a more accurate and resource demanding (on average) 3D reconstruction when the pose error is considered large (i.e. greater than the error threshold). Optionally, network conditions between the mobile device and the server are also considered for the decision to offload to the server.

The error threshold is a parameter which allows a trade-off of 3D reconstruction quality and computational/offloading cost. For example, the error threshold can be adjusted given experimental evaluations of the method in real data, where a relationship between the error threshold and the 3D reconstruction quality is evaluated. The initial value of the error threshold can be set based on previous experiments which define the relationship between a desired 3D reconstruction quality and defined values of the error threshold. For example, if an error threshold of 10 cm corresponds to an acceptable 3D reconstruction quality over previous experiments that is set as a reasonable first threshold value.

In one embodiment, when a specific load is desired on the device, and if the desired load is exceeded, the threshold is reduced. On the other hand, when the desired load is achieved, the threshold is increased.

In one embodiment, to improve robustness and accuracy of the proposed method, even if the pose error would normally be below the error threshold, server 3D reconstruction is triggered to perform a further refinement of the 3D reconstruction. For example, if the time since the last server 3D reconstruction is larger than a threshold time T, the server 3D reconstruction is performed at the server. For example, the threshold time T can be set to several seconds, or it can be set dynamically depending on the speed of motion of the device, where a smaller time Tis set if the moves fast and a larger time T if the device is moving slowly or is static. The threshold time T can also be adjusted based on the 3D reconstruction quality, by decreasing the time T down to a minimum value if the 3D reconstruction quality is low and increasing the time T up to a maximum value if the 3D reconstruction quality is high, as proposed previously to adjust the error threshold.

In one embodiment, the decision to offload 3D reconstruction to the server also considers the network conditions and the load at the server side. Given the network conditions and a load level at the server, an indicator of expected latency is obtained, indicating a time to obtain the 3D model using server 3D reconstruction. This indicator of expected latency can be requested by the mobile device, using an API provided by the server. Then, the mobile device can decide to perform the offloading if the expected latency if below a desired threshold, or not perform the offloading if the expected latency is above a desired threshold.

In the perform device reconstruction step 46, the mobile device 2 performs a device 3D reconstruction, resulting in updates to a device 3D model. Since, when this step is performed, the pose error is smaller than the error threshold, the device 3D reconstruction can be performed, which is a lightweight reconstruction (relative to the server 3D reconstruction). The device 3D reconstruction is performed in real-time, i.e. the process duration is lower than the frame rate.

If depth information is captured by the sensor (e.g. stereo camera, Lidar sensor), the device 3D reconstruction comprises a direct integration of the depth information (e.g. in a point cloud).

If depth information is not captured by the sensor (e.g. monocular camera with or without IMU), depth information can be reconstructed first using Multi-View Stereo (MVS) or other real-time non-MVS-based methods, known in the art per se. The depth information is then integrated in the model. Since the estimated pose is accurate (due to this step only being performed when the pose error is lower than the threshold), an accurate 3D reconstruction of the model is achieved with low computational cost.

It is to be noted that the 3D reconstruction does not have to be performed for every frame captured by the sensor, but instead it can operate on keyframes. Keyframes are specific frames that are identified by a specific rule, as for example, a new keyframe is selected when the mobile device has moved or rotated by more than a given threshold or that the overlap between consecutive keyframes is larger than a given threshold, or any other suitable current or future rule. Performing the 3D reconstruction in keyframes, rather than all frames, is more computationally efficient.

It is to be noted that if the server 3D reconstruction at the server is slower than the device 3D reconstruction step at the mobile device, the mobile device can continue to perform lightweight 3D reconstruction while waiting for a new and accurate 3D model (and corresponding refined poses of the mobile device) from the server. Such lightweight 3D reconstruction will be of relatively low quality, since the pose error is larger than the error threshold, but can be used for providing the mobile device with a rough 3D model which can, for example, be used to perform conservative navigation and augmented reality while awaiting the more accurate server 3D reconstruction.

In the send 3D reconstruction request step 48, the mobile device 2 sends a 3D reconstruction request to the server 3 to perform a server 3D reconstruction, when the pose error is determined to be greater than the error threshold. The 3D reconstruction request comprises data based on the sensor data, in raw sensor data from or refined in any suitable manner. In one embodiment, the 3D reconstruction request comprises at least part of a most recent device 3D model and sensor data obtained after determining the most recent device 3D model.

Optionally, the 3D reconstruction request comprises the pose estimate (determined by the mobile device 2).

The 3D reconstruction request may comprise at least part of the device 3D model build, after the most recent loop closure or localisation event, i.e. all updates to the 3D model resulting from the device 3D reconstruction.

In a receive 3D reconstruction request step 49, the server 3 receives the 3D reconstruction request from the mobile device 2. As mentioned above, the 3D reconstruction request comprises data based on sensor data obtained by sensors 7a-c of the mobile device 2.

In a perform server reconstruction step 50, the server 3 performs a server (central) 3D reconstruction, based on the 3D reconstruction request. Optionally, the server 3 also determines a pose of the mobile device. Since the pose estimate error is larger than the error threshold, when this step is performed, the pose estimate can here be refined by the server, based on the sensor data and the estimated pose from the mobile device, to thereby improve quality of the server 3D reconstruction. Such pose refinement is performed by the server 3D reconstruction, that can consume more power and can be more accurate than the device 3D reconstruction.

The server 3D reconstruction can first include pose graph optimisation and/or bundle adjustment of the poses. Subsequently, the server 3D reconstruction depends on the availability (or not) of depth data, as for the device 3D reconstruction.

If depth information is captured by the sensor (e.g. stereo camera, Lidar sensor), the captured depth data can be fused into a previously existing 3D model using methods known in the art per se.

If depth information is not captured by the sensor (e.g. monocular camera with or without IMU), depth information can be reconstructed first by using heavyweight Multi-View Stereo (MVS) methods, or using the lightweight methods mentioned above for the device 3D reconstruction. However, when run on the server, a heavyweight MVS algorithm (using more resources) can be executed, which is not feasible to execute on the mobile device 2. After the first step of depth information extraction, the integration of the depth information can be performed.

Input data (forming part of the 3D reconstruction request from the mobile device) can be based on the keyframe determination, the pose (e.g. in the form of a pose graph) determined by the mobile device, and the 3D model which is available at the mobile device at the current iteration k. Optionally, the 3D reconstruction request comprises sensor data obtained from time t>k, so that the server has the data to perform server 3D reconstructions. Optionally, the server can keep a copy of the determined server 3D model from a previous iteration. The 3D reconstruction request then comprises the data (keyframes, poses, and 3D model) from time step k-i, where i represents the iteration when the last 3D reconstruction request was sent. This reduces the amount of data sent in both directions, which reduces latency and thus the time for the server 3D reconstruction to start.

In one embodiment, the refined poses from the server 3D reconstruction are transmitted to the mobile device so that the SLAM algorithm can refine its current pose and increase the chance of identifying loop closures. Such refinement will allow a future reduced uncertainty of the current pose and the pose error, leading to fewer violations of the error threshold and thus less offloading. An updated pose graph determined by the server 3D reconstruction can then be returned to the mobile device.

In one embodiment, the 3D reconstruction step is based on a global and local model. The global model comprises a 3D model of the entire scene, e.g. mapped by SLAM, thus far. The local model is a model built from the last loop closure or localisation event at time k_i up to a time k_{i+1} when the next event of error(k)=0. The instant k_{i+1} is determined either by the mobile device if device 3D reconstruction is performed (error<error threshold) or by the server if server 3D reconstruction is performed. The local model is then fused onto the global model (see below). This embodiment can be implemented in two options. In the first option, both the local and global models are constructed and used by the device 3D reconstruction and by the server 3D reconstruction. In the second option, the local model is constructed by the device 3D reconstruction method and used by the server 3D reconstruction, while the global model is only constructed and used by the server 3D reconstruction method. The global model is made available to application(s), since the global model is more accurate and has fewer errors. The local model (which can contain erroneous poses and/or reconstructions) is only made available after validation and fusion with the global model.

The mobile device and server may jointly agree or unilaterally limit the model density, frequency or granularity in order to balance between model and source data precision, communication bandwidth, and computational, storage and energy availability.

In a send result step 52, the server 3 sends a result of the central 3D reconstruction to the mobile device 2. Optionally, the result of the central 3D reconstruction comprises the pose of the mobile device 2 that is determined by the server, as described above. The refinement in the pose performed by the server (that can use more computationally expensive algorithms) can then be used by the SLAM algorithm at the mobile device to refine its pose determination, which allows the mobile device to perform device 3D reconstruction more often over time.

In a receive result step 53, the mobile device 2 receives a result of a central 3D reconstruction from the server 3.

In a perform model fusion step 54, the mobile device 2 performs a 3D model fusion of a device 3D model (obtained within the mobile device) and the result of the central 3D reconstruction. The device 3D model, at least partly, is a result of previous device 3D reconstruction (performed by a previous iteration of step 46).

In other words, in each iteration, either device 3D reconstruction occurs in step 46 or server 3D reconstruction occurs in steps 48-54. The fusion in this perform model fusion step 54 thus occurs only in an iteration where server 3D reconstruction is performed, since it is only when server 3D reconstruction occurs that there is data to fuse with the device 3D model. But since the device 3D model is based on device 3D reconstruction (in step 46 in a previous iteration), the fusion results in a 3D model that is the result of both device 3D reconstruction and server 3D reconstruction (from different iterations).

The mobile device identifies that error(k)=0 at time instant k_0, that the error threshold violation occurred at time step k_delta and that the 3D model is received from the server at the mobile device at time step k. Given that the 3D model from the server is computed since time k_0 (i.e. only applies server 3D reconstruction for error(k)>0), the 3D model fusion is performed according to the following two actions.

In a first action, the 3D model elements of the mobile device created between time step [k_0, k] are removed, if the lightweight 3D reconstruction continued to be executed at the mobile device. In this way, all the elements in the lightweight 3D model which have an error>a small threshold (for k>k_0) are removed and will be substituted by the corresponding accurate elements in the server 3D model in the next action.

In a second action, the updated device 3D model from the first action is merged with the received server's 3D model. It is to be noted that merging two 3D models with given coordinates is a standard mathematical operation which can be performed using a common 3D library such as Open3D, see http://www.open3D.org/at the time of filing of this patent application. Further optimisation and filtering of the merged 3D models to remove noise/duplicates and obtain the optimal 3D locations of every 3D model point can subsequently be performed.

The method is repeated, for repeated 3D reconstruction that can be mobile device-based or server-based in the next iteration.

Looking now to FIG. 3B, only new or modified steps compared to those illustrated by FIG. 3A are described.

In an optional adjust error threshold step 56, the mobile device 2 adjusts the error threshold to decrease the error threshold when a quality of a device 3D reconstruction is greater than a quality threshold. Optionally, the error threshold is adjusted based on a central pose error indication received from the server 3.

As explained above, an output of the server 3D reconstruction can provide a significantly more accurate indication of the pose error, which can be used to adapt and adjust the error threshold at the mobile device. As an example, if the magnitude of the refinement of the mobile device poses (e.g. average or maximum value of translation and rotation over all poses) resulting from the server 3D reconstruction is below a server error threshold (i.e., the pose estimation error is smaller than expected), this means that server 3D reconstruction could have been avoided to be run, and device 3D reconstruction could have been performed instead at the mobile device. Such detection could trigger the increase of error thresholds (e.g., increase by X %), since a larger pose estimation error can be handled by the device 3D reconstruction method, without resorting to the server.

Similarly, if the magnitude of the refinement of the mobile device poses (e.g. average or maximum value of translation and rotation over all poses) resulting from the server 3D reconstruction is above a refinement threshold (i.e., the pose estimation error by the mobile device is higher than expected), this means that server 3D reconstruction should have been requested to be run at the server earlier. Such detection could trigger the decrease of error thresholds (e.g., decrease by X %) to be more conservative with respect to the usage of device 3D reconstruction method.

In one embodiment, the error threshold is decreased when it is desired to have a higher quality (server) 3D reconstruction, or the error threshold is increased when it is considered that a reduction in the quality of the 3D reconstruction is acceptable, tilting the balance towards device 3D reconstruction. When no ground truth data is available, one way to evaluate the reconstructions is to use geometric consistency across multiple views. This consistency can be evaluated by for example checking the average reprojection errors. Another possibility is to fit planes to the 3D points, project those points to the images, find the homography between those image points and check the error on the estimated plane parameters and poses.

Using embodiments presented herein, when the pose error is small, the device 3D reconstruction with low computational complexity is performed at the mobile device, while when the pose error is high, a high computational complexity pose refinement by a server central 3D reconstruction process is performed by the server.

The server 3D reconstruction helps to achieve an accurate 3D model and to refine the poses at the mobile device, which will have a positive effect on the user experience/application quality. Moreover, the server 3D reconstruction also allows the tuning of the threshold used by the mobile device which helps to better determine when performing server 3D reconstruction is needed. This helps to reduce unnecessary network usage and server computations. At the same time, the server 3D reconstruction is only employed when needed, as determined by the pose error.

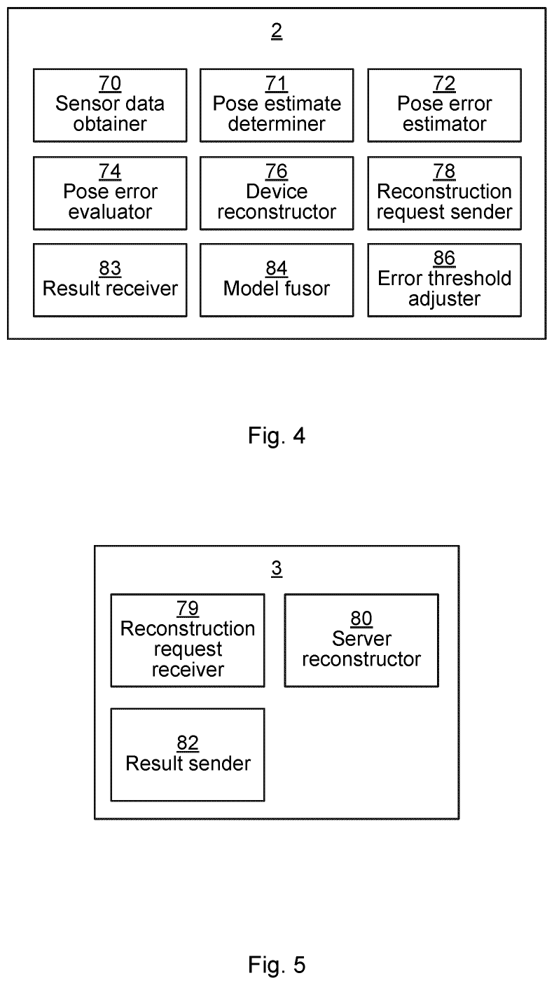

FIG. 4 is a schematic diagram showing functional modules of the mobile device 2 of FIG. 1 according to one embodiment. The modules are implemented using software instructions such as a computer program executing in the mobile device 2. Alternatively or additionally, the modules are implemented using hardware, such as any one or more of an ASIC (Application Specific Integrated Circuit), an FPGA (Field Programmable Gate Array), or discrete logical circuits. The modules correspond to the steps in the methods illustrated in FIGS. 3A and 3B.

A sensor data obtainer 70 corresponds to step 40. A pose estimate determiner 71 corresponds to step 41. A pose error estimator 72 corresponds to step 42. A pose error evaluator 74 corresponds to step 44. A device reconstructor 76 corresponds to step 46. A reconstruction request sender 78 corresponds to step 48. A result receiver 83 corresponds to step 53. A model fuser 84 corresponds to step 54. An error threshold adjuster 86 corresponds to step 56.

FIG. 5 is a schematic diagram showing functional modules of the server 3 of FIG. 1 according to one embodiment. The modules are implemented using software instructions such as a computer program executing in the server 3. Alternatively or additionally, the modules are implemented using hardware, such as any one or more of an ASIC (Application Specific Integrated Circuit), an FPGA (Field Programmable Gate Array), or discrete logical circuits. The modules correspond to the steps in the methods illustrated in FIGS. 3A and 3B.

A reconstruction request receiver 79 corresponds to step 49. A server reconstructor 80 corresponds to step 50. A result sender 82 corresponds to step 52.

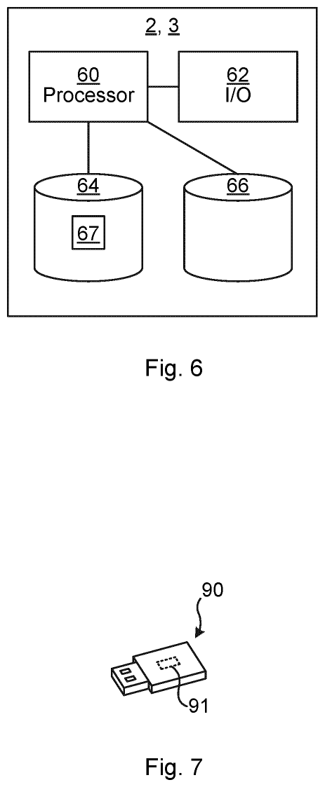

FIG. 6 is a schematic diagram illustrating components of the mobile device 2 and the server 3 of FIG. 1. A processor 60 is provided using any combination of one or more of a suitable central processing unit (CPU), graphics processing unit (GPU), multiprocessor, microcontroller, digital signal processor (DSP), etc., capable of executing software instructions 67 stored in a memory 64, which can thus be a computer program product. The processor 60 could alternatively be implemented using an application specific integrated circuit (ASIC), field programmable gate array (FPGA), etc. The processor 60 can be configured to execute the methods described with reference to FIGS. 3A-B above.

The memory 64 can be any combination of random-access memory (RAM) and/or read-only memory (ROM). The memory 64 also comprises non-transitory persistent storage, which, for example, can be any single one or combination of magnetic memory, optical memory, solid-state memory or even remotely mounted memory.

A data memory 66 is also provided for reading and/or storing data during execution of software instructions in the processor 60. The data memory 66 can be any combination of RAM and/or ROM.

There is further an I/O interface 62 for communicating with external and/or internal entities. The I/O interface 62 can also include a user interface.

Other components of the mobile device 2 and the server 3 are omitted in order not to obscure the concepts presented herein.

FIG. 7 shows one example of a computer program product 90 comprising computer readable means. On this computer readable means, a computer program 91 can be stored in a non-transitory memory. The computer program can cause a processor to execute a method according to embodiments described herein. In this example, the computer program product is in the form of a removable solid-state memory, e.g. a Universal Serial Bus (USB) drive. As explained above, the computer program product could also be embodied in a memory of a device, such as the computer program product 64 of FIG. 6. While the computer program 91 is here schematically shown as a section of the removable solid-state memory, the computer program can be stored in any way which is suitable for the computer program product, such as another type of removable solid-state memory, or an optical disc, such as a CD (compact disc), a DVD (digital versatile disc) or a Blu-Ray disc.

The aspects of the present disclosure have mainly been described above with reference to a few embodiments. However, as is readily appreciated by a person skilled in the art, other embodiments than the ones disclosed above are equally possible within the scope of the invention, as defined by the appended patent claims. Thus, while various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method for performing 3D, three-dimensional, reconstruction for use in a model of a physical environment captured by at least one sensor of a mobile device, the method being performed by a system comprising the mobile device and a server, the method comprising:
obtaining, by the mobile device, sensor data from sensors of the mobile device;
determining, by the mobile device, a pose estimate of the mobile device based on the sensor data;
estimating, by the mobile device, a pose error of the pose estimate;
comparing, by the mobile device, the pose error against an error threshold;
performing, by the mobile device, a device 3D reconstruction when the pose error is determined to be smaller than the error threshold, resulting in updates to a device 3D model;
sending, by the mobile device, a 3D reconstruction request to the server, when the pose error is determined to be greater than the error threshold, wherein the 3D reconstruction request comprises data based on the sensor data;
performing, by the server, a central 3D reconstruction based on the 3D reconstruction request;
sending, by the server, a result of the central 3D reconstruction to the mobile device; and
performing, by the mobile device, a 3D model fusion of a device 3D model in the mobile device and the result of the central 3D reconstruction, wherein the device 3D model, at least partly, is a result of previous device 3D reconstruction.

2. A method for performing 3D, three-dimensional, reconstruction for use in a model of a physical environment captured by at least one sensor of a mobile device, the method being performed by the mobile device, the method comprising:
obtaining sensor data from sensors of the mobile device;
determining a pose estimate of the mobile device based on the sensor data;
estimating a pose error of the pose estimate;
comparing the pose error against an error threshold;
performing a device 3D reconstruction when the pose error is determined to be smaller than the error threshold, resulting in updates to a device 3D model;
sending a 3D reconstruction request to the server to perform a central 3D reconstruction, when the pose error is determined to be greater than the error threshold, wherein the 3D reconstruction request comprises data based on the sensor data;
receiving a result of a central 3D reconstruction from the server; and
performing a 3D model fusion of a device 3D model in the mobile device and the result of the central 3D reconstruction, wherein the device 3D model, at least partly, is a result of previous device 3D reconstruction.

3. The method according to claim 2, wherein the sensors include at least a camera.

4-15. (canceled)

16. A mobile device for performing 3D, three-dimensional, reconstruction for use in a model of a physical environment captured by at least one sensor of the mobile device, the mobile device comprising:
a processor; and
a memory storing instructions that, when executed by the processor, cause the mobile device to:
obtain sensor data from sensors of the mobile device;
determine a pose estimate of the mobile device based on the sensor data;
estimate a pose error of the pose estimate;
compare the pose error against an error threshold;
perform a device 3D reconstruction when the pose error is determined to be smaller than the error threshold, resulting in updates to a device 3D model;
send a 3D reconstruction request to the server to perform a central 3D reconstruction, when the pose error is determined to be greater than the error threshold, wherein the 3D reconstruction request comprises data based on the sensor data;
receive a result of a central 3D reconstruction from the server; and
perform a 3D model fusion of a device 3D model in the mobile device and the result of the central 3D reconstruction, wherein the device 3D model, at least partly, is a result of previous device 3D reconstruction.

17. The mobile device according to claim 16, wherein the sensors include at least a camera.

18. The mobile device according to claim 16, wherein the instructions to determine a pose estimate comprise instructions that, when executed by the processor, cause the mobile device to determine the pose estimated based on a SLAM, simultaneous localisation and mapping, procedure.

19. The mobile device according to claim 18, wherein the instructions to estimate a pose error comprise instructions that, when executed by the processor, cause the mobile device to determine a pose error based on an odometry component that is usable for the SLAM procedure.

20. The mobile device according to claim 18, wherein the instructions to estimate a pose error comprise instructions that, when executed by the processor, cause the mobile device to reduce the pose error when a localisation of the mobile device in the SLAM procedure occurs.

21. The mobile device according to claim 20, wherein the instructions to estimate a pose error comprise instructions that, when executed by the processor, cause the mobile device to set the pose error to zero when a localisation of the mobile device in the SLAM procedure occurs.

22. The mobile device according to claim 16, wherein the result of the central 3D reconstruction comprises a pose of the mobile device determined by the server.

23. The mobile device according to claim 16, further comprising instructions that, when executed by the processor, cause the mobile device to adjust the error threshold to decrease the error threshold when a quality of a device 3D reconstruction is greater than a quality threshold.

24. The mobile device according to claim 23, wherein the instructions to adjust comprise instructions that, when executed by the processor, cause the mobile device to adjust the error threshold based on a central pose error indication received from the server.

25. The mobile device according to claim 16, wherein the 3D reconstruction request comprises at least part of a most recent device 3D model and sensor data obtained after determining the most recent device 3D model.

26. The mobile device according to claim 16, wherein the 3D reconstruction request comprises the pose estimate.

27. A computer program product comprising a non-transitory computer readable medium storing a computer program for performing 3D, three-dimensional, reconstruction for use in a model of a physical environment captured by at least one sensor of a mobile device, the computer program comprising computer program code which, when executed on the mobile device causes the mobile device to:
obtain sensor data from sensors of the mobile device;
determine a pose estimate of the mobile device based on the sensor data;
estimate a pose error of the pose estimate;
compare the pose error against an error threshold;
perform a device 3D reconstruction when the pose error is determined to be smaller than the error threshold, resulting in updates to a device 3D model;
send a 3D reconstruction request to the server to perform a central 3D reconstruction, when the pose error is determined to be greater than the error threshold, wherein the 3D reconstruction request comprises data based on the sensor data;
receive a result of a central 3D reconstruction from the server; and
perform a 3D model fusion of a device 3D model in the mobile device and the result of the central 3D reconstruction, wherein the device 3D model, at least partly, is a result of previous device 3D reconstruction.

28. (canceled)

29. A method for performing 3D, three-dimensional, reconstruction for use in a model of a physical environment captured by at least one sensor of a mobile device, the method being performed by a server, the method comprising:
receiving a 3D reconstruction request from the mobile device, wherein the 3D reconstruction request comprises data based on sensor data obtained by sensors of the mobile device;
performing a central 3D reconstruction based on the 3D reconstruction request; and
sending a result of the central 3D reconstruction to the mobile device.

30-31. (canceled)

32. A server for performing 3D, three-dimensional, reconstruction for use in a model of a physical environment captured by at least one sensor of a mobile device, the server comprising:
a processor; and
a memory storing instructions that, when executed by the processor, cause the server to:
receive a 3D reconstruction request from the mobile device, wherein the 3D reconstruction request comprises data based on sensor data obtained by sensors of the mobile device;
perform a central 3D reconstruction based on the 3D reconstruction request; and
send a result of the central 3D reconstruction to the mobile device.

33. The server according to claim 32, further comprising instructions that, when executed by the processor, cause the server to adjust the error threshold based on a central pose error indication received from the server.

34. The server according to claim 32, wherein the result of the central 3D reconstruction comprises a pose of the mobile device determined by the server.

35. A computer program product comprising a non-transitory computer readable medium storing a computer program for performing 3D, three-dimensional, reconstruction for use in a model of a physical environment captured by at least one sensor of a mobile device, the computer program comprising computer program code which, when executed on a server causes the server to:
receive a 3D reconstruction request from the mobile device, wherein the 3D reconstruction request comprises data based on sensor data obtained by sensors of the mobile device;
perform a central 3D reconstruction based on the 3D reconstruction request; and
send a result of the central 3D reconstruction to the mobile device.

36. (canceled)
